(19) United States
(12) Patent Application Publication
(10) Pub. No.: US 2007/0039381 A1
(43) Pub. Date: Feb. 22, 2007

(54) Secondary Air Injector For Use With Exhaust Gas Simulation System

(76) Inventors: Suzanne Annette Timmons, San Antonio, TX (US); Cynthia C. Webb, San Antonio, TX (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/462,567

(22) Filed: Aug. 4, 2006

Related U.S. Application Data
(60) Provisional application No. 60/705,930, filed on Aug. 5, 2005.

(51) Int. Cl. G01M 19/00

(52) U.S. Cl. 73/118.1

(57) ABSTRACT

A secondary air injector for use with an exhaust flow simulation system. A typical exhaust flow simulator is a burner-based system, in which exhaust from a combustive burner is exhausted through an exhaust line. The secondary air injector is placed downstream the burner to create a desired thermal condition or composition of the exhaust gas. The injector comprises a hollow ring fitted around the exhaust line, with multiple holes for evenly injecting the air into the exhaust line.

### RELATED PATENT APPLICATION

This application claims the benefit of U.S. Provisional Application No. 60/705,930, filed Aug. 5, 2005 and entitled “Secondary Air Injector for Use with Exhaust Flow Simulation System”.

### TECHNICAL FIELD OF THE INVENTION

The present application relates in general to systems for simulating the exhaust flow of an engine under extended driving conditions and elevated temperatures.

### BACKGROUND OF THE INVENTION

As a result of stricter regulations for automotive emissions, it was desired to design a testing apparatus and procedure for testing emissions control devices. Historically, actual internal combustion engines have been used for such evaluations. However, the use of a real engine for long term testing can be inconsistent, maintenance intensive, and expensive to operate. In addition, a real engine does not conveniently permit the separate evaluation of individual variables, such as the effects of various constituents of fuel and oil.

U.S. Patent Pub. No. 2003/0079520, entitled “Method and Apparatus for Testing Catalytic Converter Durability” and U.S. Patent Pub. No 2004/0007056 A1, entitled Method for Testing Catalytic Converter Durability”, both describe an exhaust flow simulation system. The system comprises a fuel-combustive burner with an integrated, computerized control system. The system realistically simulates the flow of exhaust gas from an engine under a variety of load conditions.

### BRIEF DESCRIPTION OF THE DRAWINGS

FIG. 1 illustrates an exhaust gas simulation system having secondary air injection in accordance with the invention.

FIG. 2 illustrates the burner of the system of FIG. 1.

FIG. 3 is a perspective view of the secondary air injector of FIG. 1.

FIG. 4 is a cross sectional view of the secondary air injector.

FIG. 5 illustrates the inner ring of the secondary air injector.

FIG. 6 illustrates catalyst bed temperatures resulting from the four modes of the EPA catalyst aging cycle specifications.

### DETAILED DESCRIPTION OF THE INVENTION

The following description is directed to a burner-based exhaust flow simulation system, which produces a flow of exhaust gas with a composition and temperature corresponding to the exhaust flow produced by an internal combustion engine. The system can be used with or without introducing oil to simulate engine oil consumption.

As an example of one application of the system, an emissions control device can be installed on the exhaust line downstream of the burner. The effect of extended driving conditions and elevated temperatures on the emissions control device can be simulated. The system can also simulate the effects of additives and contaminants from the engine. The system is capable of “aging” the emissions control device, which can then be evaluated, and if desired, performance tested on an actual vehicle.

Other applications of the exhaust flow simulation system are possible. Various sensors, such as those used for emissions monitoring and control, can be tested. Materials used to fabricate any component affected by exhaust gas can be tested. The subject of the testing may be a fuel, an additive, or an oil. Or, various environmental factors may be introduced and their effect evaluated.

U.S. Patent Pub. No. 2003/0079520 and U.S. Patent Pub. No 2004/0007056, referenced in the Background and incorporated by reference herein, each describes an exhaust flow simulation system with which the invention described herein may be used. For purposes of example, the invention is described as an improvement to those systems. However, the invention is not limited to those particular systems, and in general, can be used with any burner-based exhaust flow simulation system in which secondary air is desired to be introduced into the exhaust flow. By “secondary air” is meant air downstream of the burner, and independent of air used for fuel combustion.

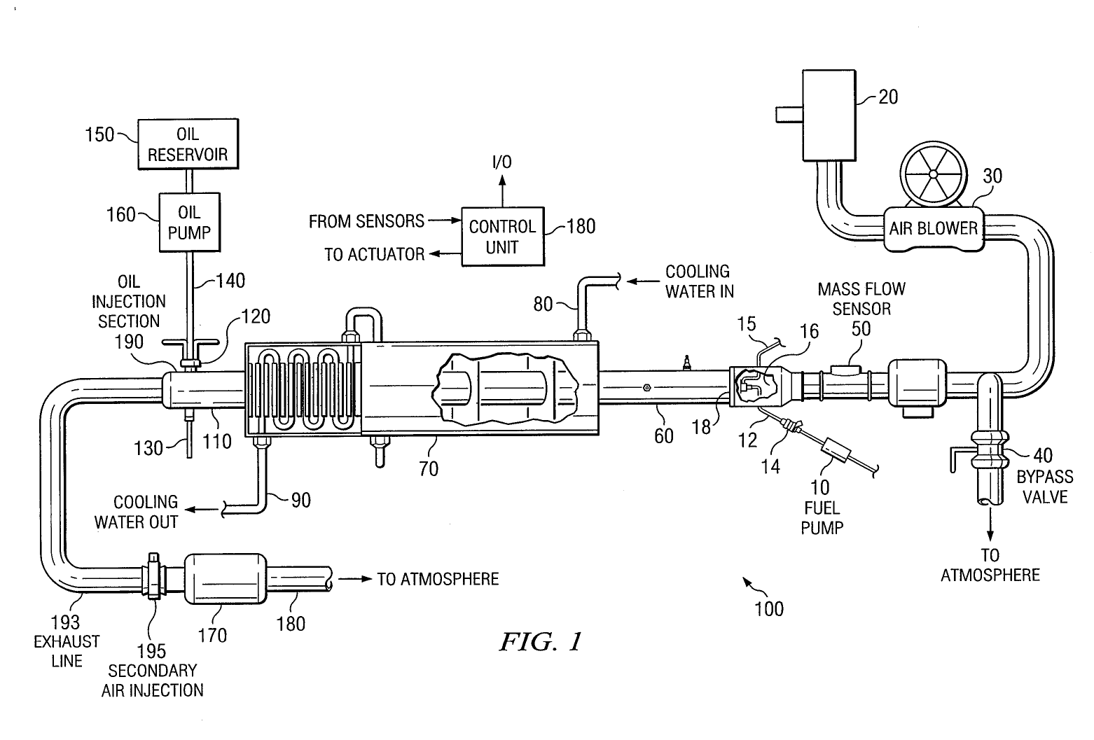

FIG. 1 illustrates a burner-based exhaust flow simulation system 100 having a secondary air injector 195 in accordance with the invention. In the example of this description, an emissions control device 170 is installed for testing. However, as explained above, system 100 has numerous applications, not all of which require installation of such a device.

As explained below, system 100 provides exhaust from combustion of gasoline or other fuel. The exhaust is provided with precise air-to-fuel ratio (AFR) control, and has a separate oil atomization system for definitive isolation of the effects of fuel and of lubricant at various consumption rates and states of oxidation. System 100 is capable of operating over a variety of conditions, allowing various modes of engine operation to be simulated, such as cold start, steady state stoichiometric, lean, rich, and cyclic perturbation.

System 100 has seven subsystems: (1) an air supply system to provide air for combustion to the burner, (2) a fuel system to provide fuel to the burner, (3) a burner system to combust the air-fuel mixture and provide the proper exhaust gas constituents, (4) a heat exchanger to control the exhaust gas temperature, (5) an oil injection system, (6) a secondary air injection system, and (7) a computerized control system.

Combustion Air Supply System

An air blower 30 draws ambient air through an inlet air filter 20 and exhausts a pressurized stream of air. A mass air flow sensor 50 monitors air flow. The volume of air supplied is set by adjusting bypass valve 40 to produce a desired flow rate of air.

The air blower 30, filter 20, and the mass air flow sensor 50 may be of any conventional design. An example of a suitable air blower 30 is an electric centrifugal blower. Control unit 180 may be used to actuate and/or receive data from the various elements of the air supply system.

Fuel Supply System

A fuel pump 10 pumps engine fuel through a fuel line 12 to a fuel control valve 14. As used herein, the term “engine fuel” means any substance which may be used as fuel for an internal combustion engine, including, but not necessarily limited to, synthetic gasoline, diesel, carbon-based liquefied fuel, methanol, or compressed natural gas.

An example of a suitable fuel control valve 14 is a solenoid valve that receives a pulse-width modulated signal from control unit 180, and regulates the flow of fuel to the burner 60 in proportion to the pulse width. Via the fuel line 12, fuel is delivered to a fuel spray nozzle 16 in the burner 60.

Burner

Burner 60 is designed to produce a desired combustion of the fuel and air. In the example of this description, burner 60 is a swirl-stabilized burner capable of producing continuous combustion at rich, lean, or stoichiometric air-fuel ratios.

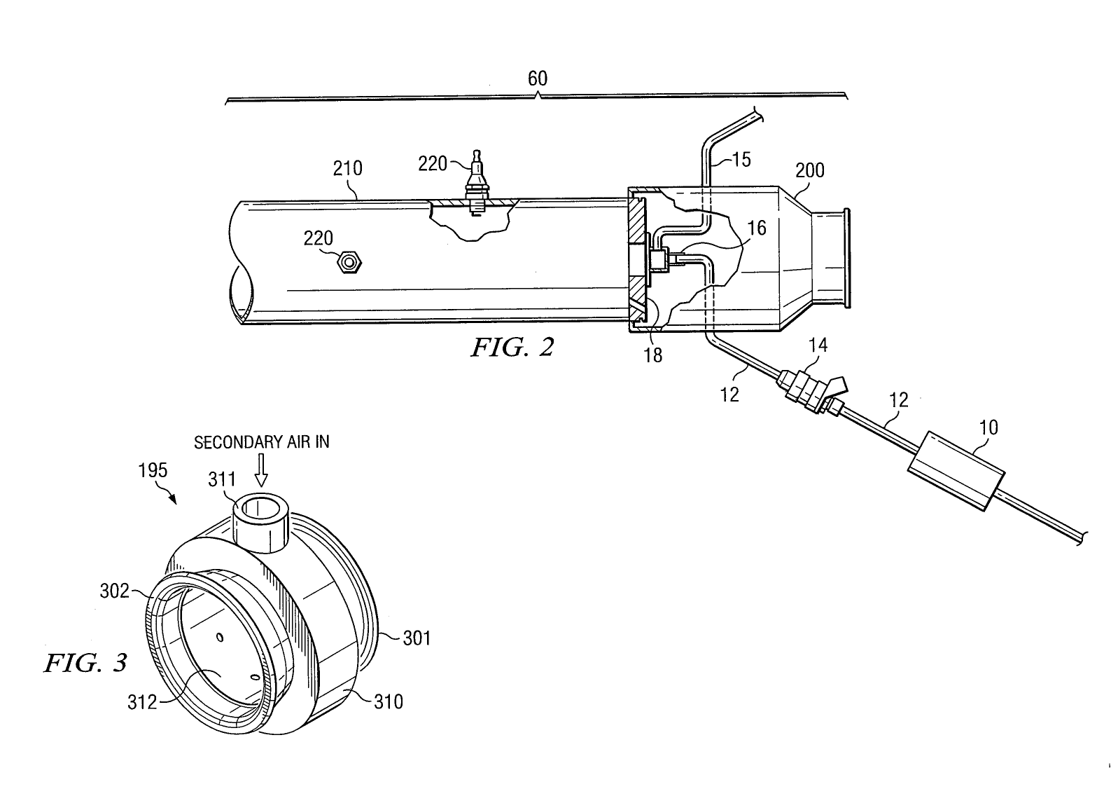

FIG. 2 illustrates burner 60 in further detail. Burner 60 has both a plenum chamber 200 and a combustion tube 210, separated by swirl plate 18. The combustion tube 210 is constructed of material capable of withstanding extremely high temperatures. Preferred materials include, but are not necessarily limited to INCONEL or stainless steel, and optionally can have a quartz window for visual observation of the resulting flame pattern.

Air and fuel are separately introduced into the burner 60. Air from mass flow sensor 50 is ducted to the plenum chamber 200, then through the swirl plate 18 into the burner tube 210.

The swirl plate 18 is equipped with a fuel injector 16, implemented as an air-assisted fuel spray nozzle 16 at the center of the swirl plate 18. The swirl plate 18 has a central bore, and spray nozzle 16 is fitted to the swirl plate 18 at this central bore using suitable attachment means.

Fuel from the fuel supply line 12 is delivered to the spray nozzle 16, where it is mixed with compressed air from air line 15. The mixture is sprayed into the combustion tube 210. The compressed air line 15 provides high pressure air to assist in fuel atomization.

Swirl plate 18 is capable of producing highly turbulent swirling combustion, so as to provide a complex pattern of collapsed conical and swirl flow in the combustion area. The flow pattern created by the swirl plate 18 involves the interaction of a number of jets bored through swirl plate 18. The arrangement and angling of these jets dictate how they direct air. For example, “turbulent jets” may be used to direct the air toward the central bore. Other jets may be used to direct air from the outer circumference of the swirl plate 18. The precise dimensions and angular orientation of the jets may vary. The jets may further be used to prevent the flame from contacting the fuel spray nozzle 16.

The swirling flow within tube 210 collapses and expands, preferably at intervals that are substantially equivalent in length to the inner diameter of combustion tube 210. In the example of this description, the inner diameter of the combustion tube 210 is 4 inches, and the interval at which the swirling flow collapses and expands is every 4 inches.

Combustion tube 210 is equipped with one or more spark igniters 220. In a preferred embodiment, three substantially equally spaced spark igniters 220 are located around the circumference of the combustion tube in the gas “swirl path” created by the swirl plate 18. An example of a suitable igniter is a marine spark plug.

The swirl pattern within combustion tube 210 may be used to define the location of igniters 220 along the combustion tube 210. In the embodiment described herein, the igniters are located at first and second full expansions along the path of inner swirl jets.

Swirl plate 18 may be implemented as a substantially circular disc having a thickness sufficient to fix the air flow pattern and to create an “air shroud” that is effective to protect the fuel injector 16. The swirl plate 18 is made of substantially any material capable of withstanding high temperature, a preferred material being stainless steel.

In some embodiments, suitable for combustion of low volatility fuels, combustion tube 210 is further equipped with ceramic foam located downstream from the spray nozzle 16. Substantially any suitable foam may be used, such as SiC ceramic foam.

Heat Exchanger

Referring again to FIG. 1, the exhaust from the burner 60 is routed to a heat exchanger 70. The heat exchanger 70 may be of any conventional design known to a person of ordinary skill in the art. In the example of this description, the heat exchanger 70 consists of two sections. An upstream section consists of a water jacketed tube. A downstream section is a vertical cross flow shell and tube heat exchanger. The vertical cross flow design minimizes steam formation and steam trapping within the cooling tubes.

Heat exchanger 70 is provided with an inlet water line 80 and an outlet water line 90 which supply and drain cooling water. The heat exchanger 70 cools the exhaust gas to reach (or assist in reaching) a desired exhaust gas temperature at the inlet to emissions control device 170.

Oil Injection System

Downstream from the burner 60, the exhaust gas is routed past an oil injection section 110, which may be used to introduce a precisely controlled amount of lubricating oil into the exhaust stream. In the example of this description, the oil injection system 110 is installed in a four inch diameter pipe, and placed in a location where the exhaust gas temperature is approximately 600 degrees C.

The oil injection section 110 provides an atomized oil spray comprising oil droplets with a sufficiently small diameter to vaporize and oxidize the oil before it reaches the emissions control device 170. The oil injection system 110 may include means for metering the consumption rate and oxidation state (unburned, partially burned, or fully burned) of the oil delivered downstream the oil injection.

In the example of FIG. 1, motor oil is withdrawn from an oil reservoir 150 by means of an oil pump 160. Substantially any type of pump may be used, preferably a peristaltic pump which feeds the oil from the reservoir through an oil injection line 140 and into a water cooled probe 120 from which the oil is injected into the exhaust gas.

Secondary Air Injection

Secondary air injector 195 is placed upstream of the emissions control device 170, and supplies air into the exhaust flow line 193. Although, this description is in terms of supplying air, injector 195 may be equivalently used to supply any other type of gas or gas mixture into the exhaust flow.

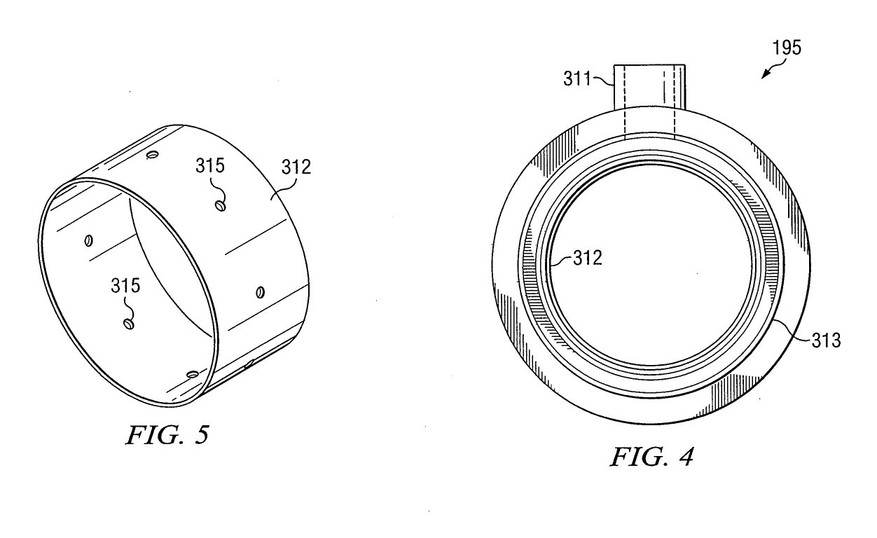

FIG. 3 is a perspective view, to illustrate secondary air injector 195 in further detail. FIG. 4 is a cross-sectional view of air injector 195. A secondary air inlet 311 receives the secondary air, which is typically from a pressurized source. Although not explicitly illustrated in FIG. 3, additional input ports can be placed circumferentially the outer wall 313 to more evenly distribute the air intake pressure.

A hollow ring 310 has a solid outer wall 313 and a perforated inner wall 312, through which the air enters the exhaust line 193. If desired, the perforated openings into the exhaust line can be offset from the inlet ports, to more evenly distribute pressure and provide even air injection into the exhaust line.

In the example of FIG. 3, air injector 195 is designed as an add-on part that can be installed into a gap in the exhaust line 193. Accordingly, it has bell-type sleeves 301 and 302 for snugly accepting ends of the exhaust pipe. Other means of attachment may be used. It alternatively possible to modify air injector 195 so that it is an integral part of exhaust line 193, such as by perforating a portion of exhaust line 193 with holes to form the inner wall 312 of secondary air injector 195 and adding the outer wall and sides to form a ring.

FIG. 5 illustrates the inner wall 312, which has eight air injection ports 315. These air injection ports 315 are placed 22 degrees off center from the main air inlet 311 to help provide a even pressure distribution and to permit even air injection into the exhaust flow tube. The use of inner wall 312 with its multiple injection ports permits the pressurized air to create a jet into the exhaust flow resulting in deeper penetration into the exhaust flow stream for better mixing.

If desired, the ports of inner wall 312 may be threaded to accept through-drilled set screws (not shown) at all eight injection locations. The set screws are the appropriate diameter to create deep penetration of the air jet perpendicular to the exhaust stream flowing up to 80 scfm or higher. The penetration depth may be changed by varying the diameter of the set screws. Other means for extending the introduction point of the air into the exhaust line (toward the longitudinal axis of the exhaust line) could be used instead of set screws.

In the example of FIG. 5, the air injection ports 315 are bored perpendicular to the surface of inner wall 312. Hence, the air enters the exhaust line 193 perpendicularly to the exhaust flow. However, in other embodiments, the ports may be angled to provide higher turbulence resulting in better air distribution in the exhaust stream.

The use of secondary air injector 195 permits rapid mixing of the secondary air, which allows the air to be injected in close proximity to the emissions control device 170 and to be sufficiently well mixed to be unstratified. It further permits the distance between the emissions control device 170 and the air injection point to be minimized to reduce or eliminate burning of oxygen and carbon monoxide in the pipe upstream of the emissions control device.

Downstream of secondary air injector 195, the exhaust gas, now mixed with the injected oil and secondary air, passes through emissions control device 170, following which the exhaust gas is vented to the atmosphere.

Control Unit

Referring again to FIG. 1, control unit 180 receives input from various sensors associated with system 100 and delivers control signals to its various actuators. Control unit 180 may be implemented with conventional computing equipment, including processors and memory. It is equipped with suitable input devices, a monitor, and a multi-function data acquisition card, connected to a digital relay module to monitor and record system information, and to control system electronics. Control unit 180 is programmed to run various simulation programs.

The sensors include sensor 50 and may further include sensors for measuring various gas contents and flows. Various measured parameters collected by control unit 180 may include: the mass air flow in the system, the air/fuel ratio (linear and EGO), the exhaust gas temperature at the outlet from the heat exchanger, the exhaust gas temperature at the inlet to the emissions control device, and the exhaust gas temperature at the outlet from the emissions control device, and various chemical constitutants of the exhaust. The information measured by the sensors is transmitted by electronic signals to control unit 180, which measures all of the monitored parameters on a periodic basis and stores the measurement data in memory.

The actuators controlled by control unit 180 include the various injectors, pumps, valves, and blowers described above. More specifically, control unit 180 controls the air-to-fuel ratio by modulating the fuel delivered to the fuel injector 16 under either an open loop or closed loop control configuration. Control unit 180 further provides a means to control ignition, air assist to the fuel injector, auxiliary air, fuel feed, blower air feed, and oil injection. An example of a suitable control system would be a proportional integral derivative (PID) control loop.

Control unit 180 monitors system 100 for safety. For example, it may be used to verify that the burner is lighted and that the exhaust is within specified limits for both temperature and air to fuel ratio. The control unit 180 is programmed to identify and address failure modes, and to monitor and control system 100 to a safe shutdown if a failure mode is detected.

Interactive interface programming of control unit 180 permits an operator to develop and run various aging cycles. The operator can use control unit 180 to investigate the effects of exposure to various oils and other fuel contaminants or additives. The inlet temperature to the emissions control device 170 can be adjusted over a wide range of temperatures.

Control unit 180 may be used to switch power to the blowers and fuel pump, as well as control the air assisted fuel injectors, burner spark, oil injection, and auxiliary air. System temperatures, mass air flow for the burner air, and the burner air to fuel ratio are measured and converted to engineering units. The software program uses measured data to calculate total exhaust flow and burner air to fuel ratio, and to check conditions indicative of a system malfunction. The burner air to fuel ratio may be controlled as either open or closed loop, maintaining either specified fuel flow or specified air to fuel ratio. Air to fuel ratio control is achieved by varying the rate of fuel delivered to the burner. Whenever necessary, open loop control can be activated allowing the operator to enter a fixed fuel injector pulse duty cycle. Closed loop control can be activated in which the actual burner air to fuel ratio is measured and compared to the measured value of the air to fuel setpoint and then adjusting the fuel injector duty cycle to correct for the measured error.

EPA Aging Cycle Specifications

For aging catalytic emissions control devices (where emissions control device 170 is a catalyst), the U.S. Environmental Protection Agency (EPA) has published thermal aging specifications, which can be used to relate thermal aging to vehicle miles driven. The cycle is known as the EPA Standard Bench Cycle (SBC) and consists of four different operating modes, as illustrated in the following table. Mode times are in seconds.

| Mode No. | Description | Operating Specification | Time |
|---|---|---|---|
| 1 | Closed-loop, | Catalyst bed temperature | 40 |
| | Stoichiometric | setpoint adjustable nominally | |
| | Fuel Control | about 865° C. | |
| 2 | Open-loop, Fuel | Rich enough to obtain exotherm | 6 |
| | Rich | temperature when reacted with | |
| | | oxygen (O₂) in Mode 3 | |
| 3 | Open-loop, | 3% O₂ to catalyst (set at | 10 |
| | Rich with Air | stoichiometric) | |
| | Injection | | |
| 4 | Closed-Loop, | Stoichiometric out of the | 4 |
| | Stoichiometric | burner, continue air injection | |
| | with Air | | |
| | Injection | | |

The SBC may be easily implemented with system 100. Time at each mode, air/fuel ratio (AFR), mass air flow, and air injection are programmed into software of control unit 180.

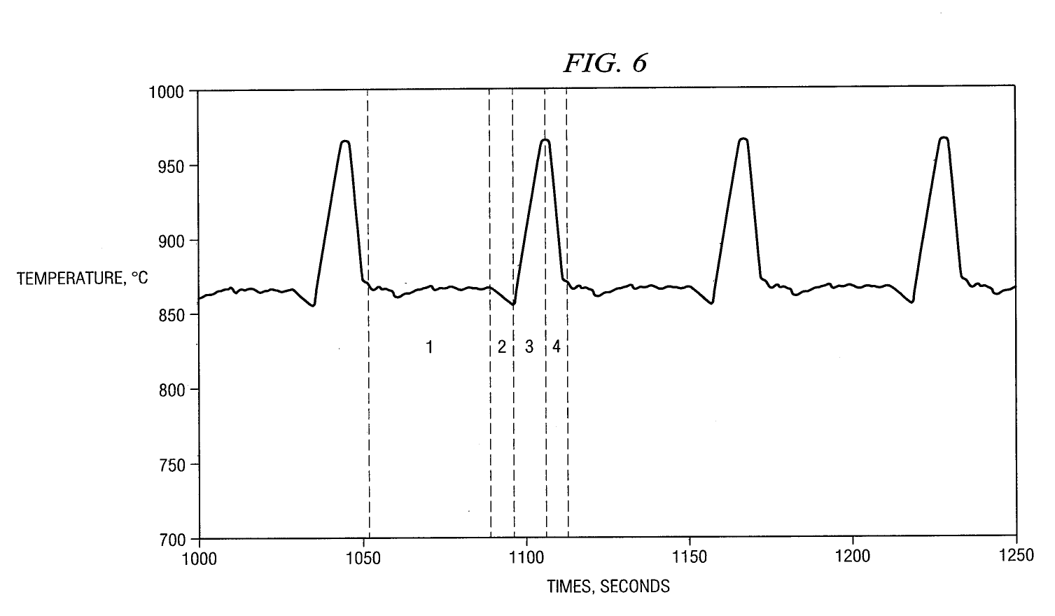

FIG. 6 illustrates typical catalyst bed temperatures, where each mode change is numerically indicated. The mode of interest for purposes of this description is Mode 3, during which a thermal excursion occurs in the catalyst. The thermal excursion is generated by operating system 100 at a fuel-rich AFR to generate about 3% carbon monoxide (CO) and injecting clean, dry air (about 3% oxygen) upstream of the catalyst. Secondary air injector 195 is used for this purpose. For Mode 3, the catalyst bed temperature is expected to peak at 90 ±10° C. above the bed temperature setpoint of Mode 1.

If the air is injected at too far a distance from the catalyst 170, a reaction between the CO and O2 will occur in the exhaust flow pipe 193 before catalyst 170, resulting in a reduction of the reactants intended to burn within the catalyst. As a result, catalyst 170 would not see the correct exotherm and is not aged properly. Additionally, it is critical that the air injected in the exhaust stream is evenly distributed. An uneven or stratified air distribution will result in uneven burning in the pipe and/or the catalyst.

An advantage of the secondary air injection device 195, as described above, is that it provides a means for injecting air without air stratification and burning in the pipe 193.

1. A secondary gas injector for an exhaust gas simulation system, the exhaust gas simulation system having an exhaust line downstream a combustive burner, comprising:
a hollow ring around the exhaust line, the ring having an outer wall and an inner wall;
at least one inlet in the outer wall for receiving a gas into the ring;
wherein the inner wall is perforated with multiple ports for injecting the gas into the exhaust line.

2. The injector of claim 1, wherein a portion of the exhaust line forms the inner wall.

3. The injector of claim 1, wherein the hollow ring is fitted into a gap of the exhaust line.

4. The injector of claim 1, wherein the ports are perpendicular to the surface of the inner wall.

5. The injector of claim 1, wherein the ports are angled relative to the surface of the inner wall.

6. The injector of claim 1, wherein the ports extend into the exhaust line toward the center axis of the exhaust line.

7. A method of simulating exhaust flow from an internal combustion engine, comprising:
combusting fuel using a burner;
exhausting the exhaust from the combusting step through an exhaust line; and
injecting a gas into the exhaust line downstream the burner;
wherein the injecting step is performed using a hollow air injection ring around the exhaust line, the ring having ports in its inner wall for injecting the gas into the exhaust line

8. The method of claim 7, wherein the gas is air.

9. A method of testing an emissions control device using an exhaust flow simulator, comprising:
combusting fuel using a burner;
exhausting the exhaust from the combusting step through an exhaust line; and
injecting secondary air into the exhaust line downstream the burner;
wherein the injecting step is performed with a secondary air injector comprising a ring placed around the exhaust line downstream the burner; and
placing the emissions control device downstream the secondary air injector.

10. The method of claim 9, wherein the combusting step is performed in modes according to EPA Standard Bench Cycle Specifications.

11. The method of claim 9, wherein the step of injecting secondary air is performed to assist a thermal excursion at the emissions control device.

12. The method of claim 9, wherein the emissions control device is a catalytic device.

13. A burner-based system for generating exhaust gas that simulates exhaust gas produced by an internal combustion engine, comprising:
a burner system having at least a burner for receiving air and fuel and for combusting the fuel to produce simulated engine exhaust;
an exhaust line for carrying the exhaust from the burner;
a secondary air injector downstream the burner installed as a ring around the exhaust line and having at least one inlet port for receiving a gas and a plurality of outlet ports for injecting the gas into the exhaust line; and
a computerized control system operable to control the burner to simulate one or more engine cycles.

14. The system of claim 13, wherein the control system is further operable to simulate engine cycles such that each cycle has a succession of engine operating modes, wherein at least one of the modes is a thermal excursion mode accomplished by providing the burner with a rich air-fuel ratio and providing supplemental oxygen into the exhaust line via the secondary air injector.
